(19) United States
(12) Patent Application Publication
(10) Pub. No.: US 2009/0267829 A1
(43) Pub. Date: Oct. 29, 2009

(54) POSITION MONITORING SYSTEM

(76) Inventors: Mark R. Mitchell, Blaine, MN (US); Paul M. Mitchell, Andover, MN (US); Boyd Palsgrove, Maple Grove, MN (US)

Correspondence Address: SCHWEGMAN, LUNDBERG & WOESSNER, P.A., P.O. BOX 2938, MINNEAPOLIS, MN, 55402, US

(21) Appl. No.: 12/093,408

(22) PCT Filed: Nov. 28, 2006
(86) PCT No.: PCT/US06/45516

§ 371 Date: Nov. 20, 2008

(51) Int. Cl. G01S 5/14; G01S 5/00

(52) U.S. Cl. 342/357.07

(57) ABSTRACT

Apparatus and systems, as well as methods and articles, may operate to provide a locating system to obtain location data for a device in order to determine whether that device is within a defined perimeter.

### RELATED APPLICATION

This patent application claims the priority benefit of U.S. Provisional Patent Application Ser. No. 60/740,087, filed Nov. 28, 2005 and entitled “MULTIPLE UNIT POSITION MONITORING SYSTEM” (Attorney Reference No. 2414.001PRV), and of U.S. Provisional Patent Application Ser. No. 60/822,157, filed Aug. 11, 2006 and entitled “GPS METHOD AND APPARATUS” (Attorney Reference No. 2414.002PRV).

### FIELD

Various embodiments described herein relate to locating devices, and more particularly to location systems and methods using GPS (Global Positioning System).

### BACKGROUND

Parents and others responsible for supervising the activities of children may sometimes find it difficult to ensure that such children do not wander away if playing outdoors. In addition, it is also sometimes difficult to keep a pet, such as a dog, within a desired area in the absence of a fence or wall enclosing the area. Accordingly, there is a need for methods and devices to reduce these difficulties.

### BRIEF DESCRIPTION OF THE DRAWINGS

FIG. 1 is a block diagram of a system according to an embodiment of the inventive subject matter.

FIG. 2 is a diagram of a base unit according to an embodiment of the inventive subject matter.

FIG. 3 illustrates the creation of a perimeter according to various embodiments.

FIG. 4 is a diagram of an implementation of a remote device on a dog collar according to various embodiments.

FIG. 5 is a diagram of an example perimeter monitoring implementation according to various embodiments.

FIG. 6 is a block diagram of several modes that may be available according to various embodiments.

FIG. 7 is a block diagram of several modules that may be involved in a base unit according to various embodiments.

### DETAILED DESCRIPTION OF THE EMBODIMENTS

In the following detailed description of exemplary embodiments, reference is made to the accompanying drawings that form a part hereof, and in which is shown by way of illustration specific exemplary embodiments which may be practiced. These embodiments are described in sufficient detail to enable those skilled in the art to practice the various embodiments, and it is to be understood that other embodiments may be utilized and that logical, mechanical, electrical and other changes may be made without departing from the scope of this disclosure. The following detailed description is, therefore, not to be taken in a limiting sense.

The following embodiments and others may be implemented in one or a combination of hardware, firmware and software. Embodiments may also be implemented as instructions stored on a machine-readable medium, which may be read and executed by at least one processor to perform the operations described herein. A machine-readable medium may include any mechanism for storing or transmitting information in a form readable by a machine (e.g., a computer). For example, a machine-readable medium may include read-only memory (ROM), random-access memory (RAM), magnetic disk storage media, optical storage media, flash-memory devices, electrical, optical, acoustical or other form of propagated signals (e.g., carrier waves, infrared signals, digital signals, etc.), and others.

In the Figures, the same reference number is used throughout to refer to an identical component which appears in multiple Figures. Signals and connections may be referred to by the same reference number or label, and the actual meaning may be clear from its use in the context of the description.

According to one example embodiment of the inventive subject matter, there is disclosed a method and apparatus to allow a user to locate and track a number objects. In one example embodiment of the inventive subject matter GPS and RF technology are used to capture and report the coordinates of the remote tracked units to a central base unit that may in one embodiment be portable. Optionally, the base unit may have a fixed or stationary location The user may be presented with the location information on a LCD screen.

### Overview

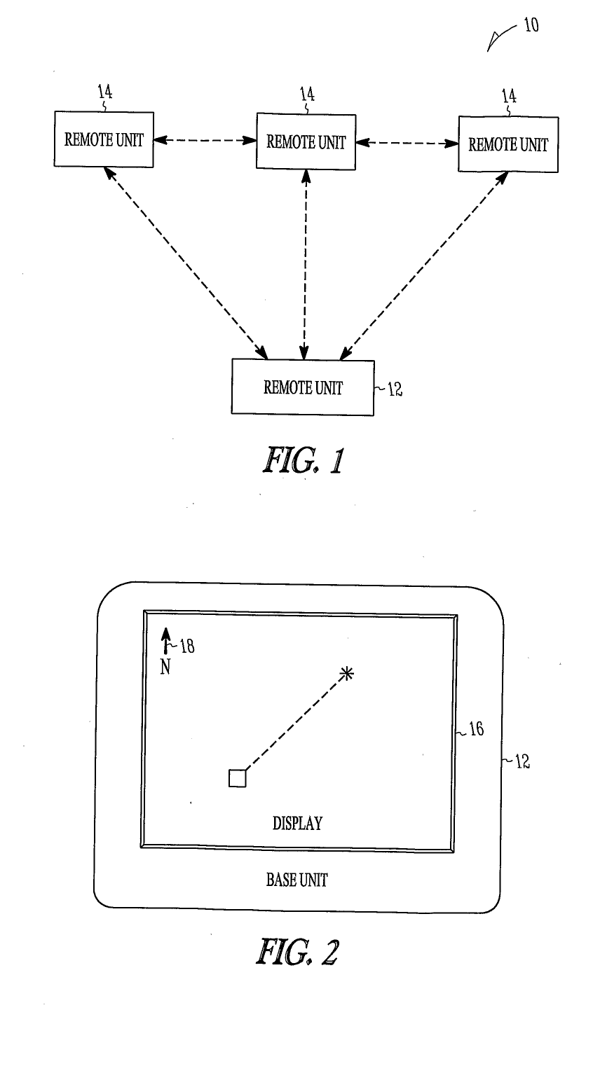

FIG. 1 is a block diagram of a portable position monitoring system 10 and comprises a portable base unit 12 and one or more portable remote units 14 that are each communicatively linked to the base unit 12 through wireless communication means. Each of the remote units 14 and the base unit 12 may be GPS-enabled transceivers that transmit and receive signals from GPS satellites in a conventional manner so as to operably obtain and provide a geographical location for each of the remote units 14 and the base unit 12. According to some embodiments of the inventive subject matter, however, only the remote units 14 are GPS-enabled transceivers, with the base unit 12 optionally being preprogrammed to represent designated locations or boundaries. According to another example embodiment, the base unit may be fixed in position, such as in a home.

According to various embodiments of the inventive subject matter, the remote units 14 periodically or continuously transmit their respective GPS-identified location to the base unit 12 through wireless communication techniques including, for example, direct radio frequency transmissions. Such a wireless communication technique enables the system 10 to be fully independent of a separate and distinct network communication system.

Through the self-contained network of the system 10, the base unit 12 is able to track the location, preferably the absolute position, of each remote unit 14. In embodiments of the inventive subject matter wherein the base unit 12 is GPS-enabled to obtain its own geographical location, the base unit 12 may additionally track the positions of each remote unit 14 communicatively linked to the base unit 12 in the system 10 relative to one another and/or relative to the base unit 12. As such, the absolute and/or relative positions of each remote unit in system 10 may be computed by the base unit 12, and displayed in a visual display incorporated with the base unit 12. The display may uniquely identify each remote unit 14 within the system 10, such that a user may readily discern the location and identity of each remote unit 14 within the system 10. A variety of tracking and display options are contemplated as being useful in the display portion of base unit 12.

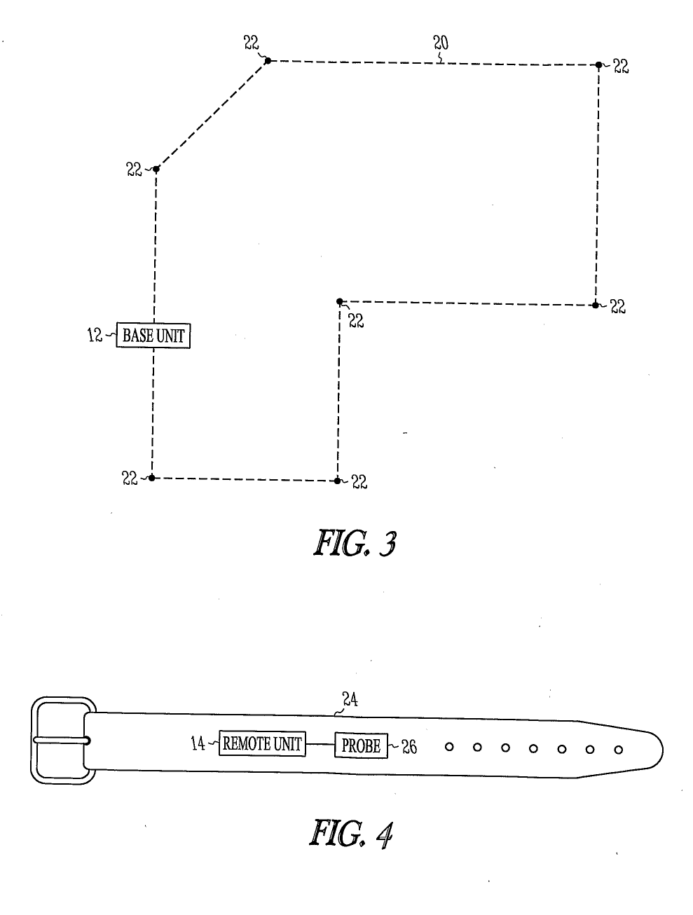

FIG. 2 illustrates an example of a visual display 16 on a base unit 12, wherein the relative position between the base unit 12 and a remote unit 14 is visually depicted. In some embodiments of the inventive subject matter, a digital compass 18 is provided at the display 16, such that relative direction between the base unit 12 and a remote unit 14 may be observed. Other features, such as distance between the remote units 14, absolute position based on longitude and latitude coordinates, and other positional or geographical information may be further provided on the display 16, as desired per application.

In accordance with various embodiments of the inventive subject matter, the remote units 14 are capable of transmitting location information directly to the base unit 12 over a range of several kilometers. In fact, the system 10 may be capable of simultaneously tracking the positions of one or more units within system 10, wherein such units are, for example, up to 25 km apart from one another. It is contemplated, however, that such a range may be greater if the technology and power so permit. To obtain a range of up to about 25 km, the remote units 14 may transmit radio frequency wave forms at a power of at least about 2 watts. Such remote units 14, therefore, incorporate internal amplification mechanisms to generate the power necessary to carry a signal over many kilometers to the base unit 12. It is also contemplated that such range may be extended by relaying the GPS location information through intermediate transmittal receivers, or through a mobile telephone or data network.

The power required to generate the above-described signal can create significant drain upon the portable energy sources incorporated with the remote units 14. Accordingly, it is a further aspect of an embodiment to incorporate energy saving mechanisms in such remote units 14 to save as much power as possible in reserve for any necessary long-range communications to the base unit 12. For example, the remote units 14 may only intermittently transmit location information to the base unit 12. Such intermittent communication may be designated by the user to occur only at selected times. As such, the communication between the remote units 14 and the base unit 12 may be automatically or manually generated, as is desired per application.

In some embodiments of the inventive subject matter, the remote units 14 are configured to receive direct communication from the base unit 12 and/or other remote units 14 within the system 10. As such, it is contemplated that each remote unit 14 within the system 10 may be configured to transmit their own respective GPS-identified location to at least selected ones of the remaining remote units 14 in the system 10, as well as to receive like information from such other remote units 14 in system 10, so that each remote unit 14 within the system 10 is able to track the positions of selected ones of every remote unit 14 within the system 10. To facilitate such tracking, the remote units 14 may further include a visual display similar to that described above with reference to the display 16 on the base unit 12. In some embodiments of the inventive subject matter, the base unit 12 itself may be configured for transmission of its GPS-identified location to the remaining remote units 14 within the system 10.

With reference to FIG. 3, according to various embodiments of the inventive subject matter, a perimeter 20 may be defined by moving the base unit 12 along a desired path. The base unit 12 may be put into a mode to retrieve its GPS location data along a path and to store that data as the boundary for a perimeter 22. In this manner, the perimeter may be stored as a series of points or coordinates defining a path. By defining the perimeter as a series of coordinates, the perimeter may take any shape, geometric or otherwise. Alternatively, according to another embodiment, the base unit 12 may be moved along a perimeter 22 and specific corner points or “fence posts” 22 may be input, and the perimeter 22 data may be stored with respect to the fence posts 22. In this manner, the perimeter may be stored as a number of points and vectors between the points. The perimeter may also be described as a circular area by defining a center point and a particular radial length. Other methods of defining a perimeter are also contemplated as embodiments of the inventive subject matter. These methods include using two or more base units to create boundary points or lines based on the location of the base units.

The perimeter itself may be created in a number of ways. According to one embodiment of the inventive subject matter, a boundary creation tool may be used to create a customized perimeter. The boundary creation tool may reside on the base unit or alternatively on a personal computer or an internet website or other convenient places for a user to access. The tool may allow a user to create a perimeter as described above by recording GPS coordinates. Alternatively, perimeter information may be created by simple drawing of lines and points. In yet another embodiment of the inventive subject matter, perimeter information may be downloaded from the a computer network, or created using mapping software. A number of embodiments are contemplated for the creation of the perimeter information. Additionally, the perimeter need not be fixed. Once defined, the perimeter may be moveable at a predetermined rate, or with reference to a base unit or a remote device, or some other mobile reference point.

With reference to FIG. 4, a particular implementation of the system 10 involves a remote unit 14 being incorporated in a pet collar 24. Such a remote unit 14 may be adapted to automatically periodically or continuously transmit its GPS-identified location to the base unit 12 so that the pet owner may monitor the location of the respective pet. A variety of operational options may be further included in such a system to enhance the overall effectiveness of the location monitoring apparatus. For example, a perimeter as described above may be programmed into base unit 12 to define a “safe zone” within which the pet may be allowed to freely roam. Once the remote unit 14 on the pet collar 24 attached to the particular pet goes beyond the predefined boundary, a visual or audio alarm may be activated at the base unit 12 to alert the operator to the undesired location of the pet. In other embodiments of the inventive subject matter, base unit 12 may be configured to emit an instructional signal to remote unit 14 to activate an electrical pulse to an exterior surface or probe 26 extending from remote unit 14 and in contact with the pet, so as to “shock” the pet when, for example, the pet has traveled beyond the predefined boundary. Other options and capabilities are contemplated as being useful according to various embodiments of the inventive subject matter, which options and capabilities may be directed through wireless radio frequency communication between the respective units of the system 10.

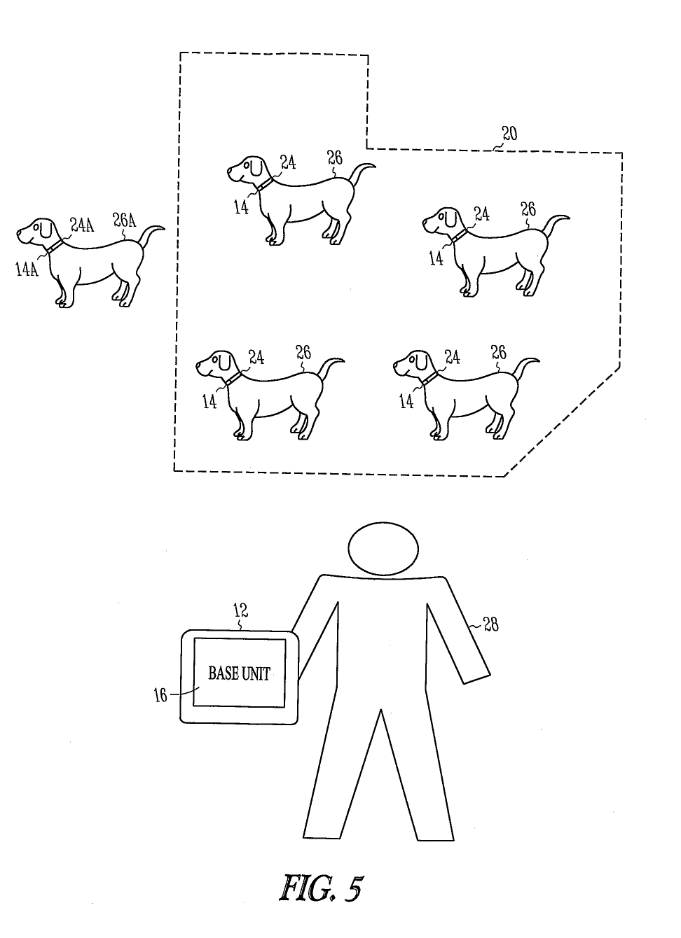

Referring to FIG. 5, a perimeter 20 is set up around a number of dogs 26. Each dog is wearing a pet collar 24 equipped with a remote device 14. From another location, the user 28 can monitor the dogs 26 using the base unit 12. According to one embodiment of the inventive subject matter, displaying the location of each dog 26 on the display 16 may be confusing, or may be too much information to show if the display 16 is relatively small. The base unit may optionally display the location of a remote unit 14 if the remote unit 14 is outside of the perimeter (see dog 26A). In this case, because remote unit 14A is outside of the perimeter 20, the base unit 12 may alert the user 28 and the display 16 may show the location of dog 26A wearing remote unit 14A with respect to the base unit 12. According to this embodiment, tracking and location information only needs to be displayed to the user 28 when a remote unit 14 has crossed the perimeter 20. This embodiment may also be applicable to teachers or parents trying to keep track of children, or a number of other similar situations.

### System Detail

According to one example embodiment, the system is made up of a single base unit and one or more remote units. The user manipulates the base unit to determine the location of the remote units, the direction from the user, the speed and heading of the remote unit and the distance to the remote unit from the base unit.

The following features may be available according to one or more embodiments of the inventive subject matter:
A base unit may be a portable battery operated device.
A remote unit may be a portable battery operated device.
The base unit may provide 24 hours of service under nominal usage conditions.
The remote unit may provide 72 hours of service under nominal usage conditions.
The base unit may provide a LCD screen for the user interface.

### Remote Units

The remote units may be attached to the objects to be tracked. The remote units need to be small and relative light so that it can be attached to smaller pets. The remote unit may consist of a battery, a GPS module, and a RF module. The battery may include a charger or a charging circuit. The battery on the remote unit may be charged with an external power supply using a universal or custom connector according to some embodiments of the inventive subject matter. The system intelligence for the remote unit may be placed in the RF module.

The following features may be available according to one or more embodiments of the inventive subject matter:
The remote unit may be enrolled with only a single base unit at a time.
The remote unit may support reenrollment.
The remote unit may support 1 or more frequency for reporting GPS coordinates to the base unit.
The remote unit may send the GPS X, Y, Z to the base unit at regular intervals while it is active.
The remote unit may send the battery status to the base unit at regular intervals while it is active.
The remote unit may support a battery saver mode to preserve the battery life once the battery has less than a certain life left.

### Base Unit

According to one example embodiment, the base unit is similar to a PDA (Portable Digital Assistant) in size, weight and portability. The base unit may contain a LCD screen, a number of buttons, and internally, GPS and RF modules. The base unit has the capability of determining its GPS location, communicate to the remote units through a RF link, determine and display a compass heading, generate a tone, display location information of the active remote units on a LCD screen, and take user input through pushbutton keys.

Through the course of operation, the user may be presented with several modes of operation. When the unit is powered on, the user may be presented with the startup mode. During the startup mode, the base unit is acquiring a GPS lock, and determining which remote units are powered on and within range.

The tracking mode is the mode where the remote units are tracked. In this mode, information is gathered from each active remote unit through the RF module, and displayed on the base unit LCD screen. The position of the remotes is displayed relative to the position of the base unit.

Fence definition mode is used to define a perimeter that is based on a collection of GPS waypoints. The user can monitor the fence building process by viewing the LCD screen. The base unit uses the GPS coordinates that it collects to build a geographical fence.

Enrollment mode is a mode that allows the user to pair a remote unit with the base unit. Once this pairing is performed, the base unit can track the remote unit. Otherwise, the base unit ignores the presence of the remote unit.

The base unit firmware may provide modes of operation that keeps the user informed of progress during the base units GPS first fix operation, normal tracking and locating operation, while building an electronic fence, and while the user enrolls remotes to the base unit.

### Startup Mode

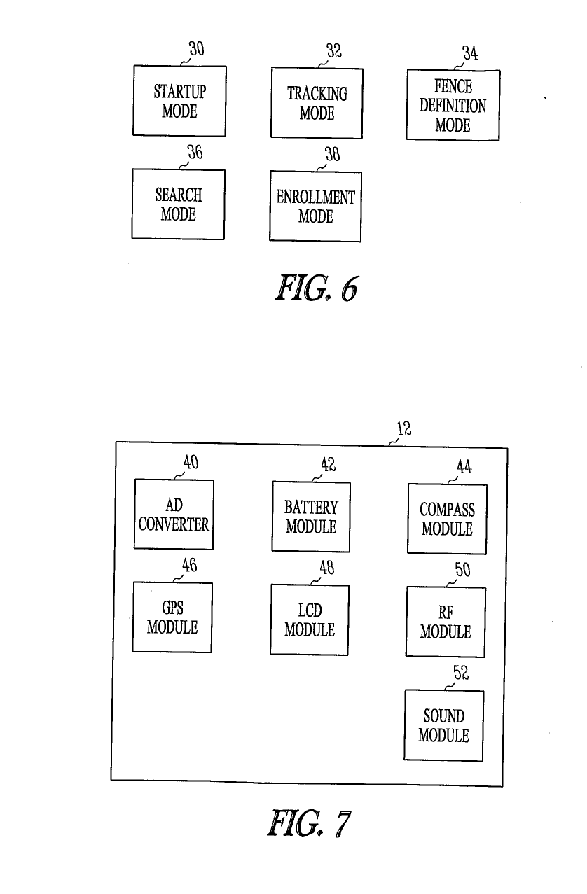

With reference to the operational modes laid out in FIG. 6, when the user powers on the base unit, it may enter startup mode 30. In startup mode 30, the base unit may attempt to acquire a GPS fix, and determine which remotes it can communicate with. Initially, the startup mode may display a splash screen. This splash screen may help “brand” the base unit and welcome the user.

Upon power on, the base unit may display a splash screen (or sequence of screens) for a desired number of seconds.

Once the splash screen has been displayed, the user may be given a visual indication, through the use of an icon, the status of the initial GPS fix.

After the splash screen has been displayed, the status of the initial GPS fix may be displayed. Until a valid initial GPS fix has been obtained, an acquiring GPS fix icon may be displayed.

The startup screen may also display a status bar on the LCD screen. While the GPS module in the base station is attempting to acquire an initial GPS fix, the base station may determine which units are powered on and within range. The remote units found to be turned on and in range may be displayed as active in the status bar. The initial GPS fix status of the remote units found may also be displayed. To aid the user in the determination of the remaining battery life of the remote unit, a battery icon may accompany the remote unit icon.

The following features may be available according to one or more embodiments of the inventive subject matter:
In startup mode 30, the base unit may determine which bonded remote units are powered on and within range. Those bonded remote units found and within range may be displayed.
The remote units displayed in the wayside rest are may contain an acquiring GPS fix icon while the corresponding remote unit is acquiring the initial GPS fix.
Each remote unit displayed may contain a battery icon that provides an indication of remaining battery life. The battery icon may contain 0, 1, 2, or 3 bars corresponding to <15%, from 15% to <50%, from 50% to <85%, >85% respectfully. According to an alternative embodiment, the battery icon may contain 0, 1, 2, or 3 bars corresponding to <25%, from 25% to <50%, from 50% to <75%, >75% respectfully, or other combinations of battery life percentages.
Each icon displayed for the remote units may be unique as to allow the user to differentiate between them. The same icon for a remote unit must be used from one use session to the next.

Once the base station has acquired an initial GPS fix, the startup mode 30 has been completed and the base station operation may proceed to the tracking mode screen without further user intervention.

Once the initial GPS fix for the base station has been established, operation of the base station may continue in the tracking mode 32.

### Tracking Mode

With reference to the operational modes laid out in FIG. 6, tracking mode 32 provides the user with direction, distance, velocity, and other status of the remote units being monitored.

The tracking screen contains a relative overall view of the base station and the remote units. The base station may be centered, with the remote stations displayed relative to their position. The built in compass may be used to rotate the remote units on the screen such the physical direction corresponds to the screen position. This provides a more natural interface such that the user doesn't have to translate the direction on the screen to a real world direction.

The following features may be available according to one or more embodiments of the inventive subject matter:
When fully zoomed in, the portion of the screen devoted to the tracking of the remote units may cover 150 feet along the X or Y axis, whichever is the smaller dimension.
When fully zoomed out, the portion of the screen devoted to the tracking of the remote units may cover 7500 feet along the X or Y axis, whichever is the smaller dimension.
A pair of physical switches may control the level of zoom in or zoom out.

The level of zoom in or zoom out may be communicated to the user on the LCD screen.
The tracking screen may rotate to maintain the compass bearing.
The compass bearing may be checked a number of times a minute.
According to one embodiment, the compass bearing may be checked once every second.
The remote units may be displayed in the tracking area scaled from the base unit, and position by compass bearing taking the current compass bearing into account.

In general, it is easier for the user to relate to positions of objects with respect to themselves. To aid in use of the base station, the base station may be placed in the center of the tracking screen with the remotes units in their corresponding positions around it.

The user may be provided with the ability of creating and using an electronic fence. This fence may be defined in GPS coordinates. The user will have the ability of turning on and off the electronic fence. When appropriate, the electronic fence may be displayed in the tracking screen, scaled and rotated as appropriate. When the electronic fence is turned on, the user may be given an alarm when one or more remotes approach or pass through the electronic fence.

The following features may be available according to one or more embodiments of the inventive subject matter:
The electronic fence may have, and be displayed with a width that may compensate for the GPS inaccuracies.
The state of the electronic fence may be saved between sessions. If the electronic fence is turned off when the base unit is powered off, when turned back on, the electronic fence may remain off. Likewise, when the electronic fence is turned on when the base unit is powered off, it may be turned on when the base unit is powered on.
The electronic fence may display an indication in the tracking area of the LCD screen showing where the fence is, providing that the zoom factor allows it.
When the electronic fence has been turned on, an electronic fence icon may be displayed. When the electronic fence has been turned off, an electronic fence icon shall not be displayed.
If the user attempts to be turn on the electronic fence when one has not been defined; an alert may be presented to the user.
When one or more of the remotes approach and pass through the electronic fence when it is turned on, the user may be presented with an alert.

When the scale of the tracking screen is such that one or more remotes can no longer be drawn within the confines of the screen, the PIP mode for those remotes off the screen may be invoked. The remote icon may change to an arrow. This arrow may be pinned to an edge of the screen and may point from the base unit to where the remote unit would be displayed of the physical screen were large enough to contain it.

According to an alternative embodiment. the PIP may be shown in one of eight positions around the perimeter of the tracking screen. These PIP screens may be used to track the remotes that have left the screen (at the current scaling). The remote that is off the screen may be displayed in the one of eight PIP locations that most closely maintains it relative position. While the PIP is on the screen, it may be semitransparent to allow any other remote being track, and under the PIP, to still be seen by the user. In the PIP, the base station may be either centered along the line, or the corner, whichever is closest to the center of the tracking screen. The scale from the PIP base station icon to the closest edge of the tracking screen may be such that it allows for the full range of the remote. To aid the user in the determining which remote is in the PIP and which may be under it, the icons contained in the PIP may be smaller than those used on the tracking screen.

### Fence Definition Mode

With reference to the operational modes laid out in FIG. 6, according to another example embodiment, the method and apparatus of the inventive subject matter may allow the user to define an electronic fence utilizing a fence definition mode 34. This electronic fence is used to provide a perimeter that when a remote unit approaches and breaches the electronic fence, a warning is issued to the user. The electronic fence is defined by a set of GPS coordinates. Before the electronic fence can be used, the user must first define the fence.

The following features may be available according to one or more embodiments of the inventive subject matter:
When shipped, the base unit may not contain any electric fence definitions.
The base unit may support a number of electronic fence definition at a time.

To use the fence definition mode 34, the user may define or redefine the electronic fence by pressing the option and create fence buttons simultaneously, slowly walk the fence perimeter, using the fence button to create a fencepost, and pressing the option and create fence buttons again. Since the fence is defined using GPS coordinates, the user may define the fence once the initial GPS fix has been accomplished. The user should be kept informed of the progress of the operation by displaying the portion of the fence currently defined and the number of fence posts that are stored in memory.

The following features may be available according to one or more embodiments of the inventive subject matter:
The fence may only be defined when the base unit is in the tracking mode 32.
When in tracking mode 32, the fence definition mode 34 may be entered when the option and fence button are pressed simultaneously.
Alternatively, fence definition mode 34 may be entered by pressing a define fence button.
Once in fence definition mode 34, exit back to tracking mode 32 may be made when the option and fence button are pressed simultaneously.
When in fence definition mode 34, GPS coordinates are collected when fence posts are defined by pressing the fence button and are used to create the electronic fence.
The current progress of the fence definition may be displayed on the LCD screen along with the indication of the GPS lock and the number of fence posts defined.
When exiting from fence definition mode 34 into tracking mode, the electronic fence shall be turned on.

### Search Mode

With reference to the operational modes laid out in FIG. 6, search mode 36 may optionally be used to aid the user of the base unit find one or more of the remote units. To preserve power, the remote units may only occasionally transmit their location. When in search mode 36, the remote units may transmit their position more frequently.

The following features may be available according to one or more embodiments of the inventive subject matter:
The base unit may support a search mode 36.
This search mode 36 may request all the remote units to return their GPS coordinates at a more frequent than normal rate.

An additional feature of search mode 36 is to allow additional base stations join the search. When additional base units join the search, those units may suspend tracking of their remote units and may start tracking the remote units of the target base station.

### Enrollment Mode

With reference to the operational modes laid out in FIG. 6, before the base unit may communicate with to the remote units, an enrollment mode 38 may be entered in order for an enrollment process to take place. Once enrolled, the remote units and the base units are allowed to communicate with one another. The user may enroll a remote unit into one of a number of separate slots. The user may select which of the slots to use by pressing the corresponding enrollment button. The user may be allowed to reenroll the unit into a different slot, removing it from the previous slot.

The following features may be available according to one or more embodiments of the inventive subject matter:
The base unit may allow a remote unit to be enrolled into one of one or more slots.
The enrollment mode 38 may be entered/exited by simultaneously pressing the option and enrollment buttons. Alternatively, the enrollment operation may be available during the startup mode.
The base unit may allow a previously enrolled remote to be reenrolled into the same or a different slot. If it is reenrolled into a different slot, the remote is removed from its previous slot.
The base unit may indicate a successful enrollment operation by illuminating a LED once the enrollment operation has been successful concluded and may extinguish it once the enrollment button is released. If the enrollment operation is unsuccessful, the LED may not be illuminated.

### Example Implementation

The following represents detailed descriptions of features and functions according to one or more example embodiments of the inventive subject matter. The following is not meant to limit the previous sections or the claims, it is provided as a detailed disclosure of a practical implementation according to one or more embodiments of the inventive subject matter. Various alternatives are available according to other embodiments of the inventive subject matter.

According to one example embodiment, there is provided a RF Module designed to provide RP communication for the “Base” and “Remote” products. The RF module hardware for the base and remote is very similar. The firmware has significant differences, as the module on the remote must communicate to the GPS module and the module on the Base must communicate to the Base processor.

Remote

The RF module on the remote performs the following functions:
Receive commands from the base over the RF link. These commands put the remote in different “modes”. These modes include various update rates and sleep modes.
Configure the GPS module to the correct TricklePower settings for best battery life, based on the mode requested by the base.
Poll the GPS module for GPS position data.
Communicate GPS position data to the base over the RF link according to the current update rate.
Monitor the battery level and communicate it to the base as part of the normal updates.
Monitor a momentary switch for enrollment packet transmission.

Base

The RF module on the base performs the following functions:
Transmit commands to the remote over the RF link. These commands put the remote in different “modes”. These modes include various update rates and sleep modes.
Communicate with the host processor over the UART connection. This communication allows the host to put the RF module in various states, enroll or delete remotes from the RF module, put enrolled remotes in various modes, and request data from the RF module relating to enrolled remotes.
Keep track of latest position data from all enrolled remotes.
Optionally keep a list of “emergency” remotes and provide a means of communicating the IDs of these remotes to other bases.

### RF System Operation

Physical Layer

The link between RF modules operates on one of the five MURS channels. The frequency and bandwidth are as follows:

| Band | Frequency | Bandwidth |
|---|---|---|
| MURS Chan 4 | 154.600 MHz | 20 kHz |

The MURS bands allow 2 watts maximum transmit power. This, along with the favorable propagation characteristics of these frequency bands, allows for significant range.

Manchester encoding is used to encode the RF packet data. The narrow bandwidth requirements of the MURS bands forces a slow RF data rate of 2.777 kbps. The RF data is modulated on the carrier in an FSK manner with a deviation of approximately 5 kHz.

RF packet length from remote to base is approximately 78 ms. RF packet length from base to remote is approximately 41 ms.

Channel Usage

Channel usage may be on a random basis. Remotes that are updating on a certain schedule (every 2 seconds, for example) may dither their random transmissions around the 2-second tick. The average time between packets may be 2 seconds, but the actual time between any 2 packets may vary randomly. Any device that wishes to transmit, remote or base, may first check to see if the channel is being used by another device in range. If so, the transmission is postponed for a random wait period, at which time the device may try again. The base and remote may each keep their receivers on anytime they are not transmitting.

Remote Operation

Modes

The remotes send GPS position updates to the base at regular intervals. The interval is configured by the base by transmitting to the remote. The minimum update interval is 2 seconds. Each separate update rate is defined as a different remote “mode”. The remote also has an inactive mode, in which it does not transmit at all. During all modes, the remote has its receiver on to listen for new commands from the base.

The remote may decide to automatically drop down to a lower update rate if there has been no movement of the remote since the last update. The method for determining whether the remote has moved is TBD.

Immediate Update

The user may request an immediate update in GPS position for one of the remotes. In this case, the host tells the base RF module to command that remote to go to the fastest update rate, which is every 2 seconds. Upon reception of this command, the remote enters 2 second update mode, asks the GPS module for a new fix, and transmits the new fix back to the base on the next opportunity. The best case response time for the immediate update is 2 seconds, and the worst case is 4 seconds.

Enrollment

The base radio module is capable of enrolling up to three remotes. Each remote is enrolled by its 24 bit random ID, and is given a unit number by the base, ranging from 0-2. Enrollment is accomplished by putting the base module in a special enrollment mode via the user interface, then causing the remote to transmit a special enrollment packet by holding a momentary switch down for three seconds. Alternatively, the option and enrollment buttons may be held down to accomplish enrollment.

Enrollment is a three packet process. The first packet from the remote is asynchronous, occurring when the momentary switch has been down for three seconds. If the base hears the enrollment packet from the remote and is in enrollment mode, it may transmit a response. This response is on the correct time slot for the unit number the base may enroll the unit into. Upon reception of the response, the remote stores its new unit number and operation mode, and transmits its acknowledgement. Only upon reception of the acknowledgement does the base enroll the remote. This ensures that the remote is only enrolled into the base if it has the correct unit number and avoids issues with multiple remotes having the same unit number.

The base module may allow a particular remote to be enrolled in only one slot. If enrollment is attempted again for the same remote, the base module may perform the requested enrollment but may delete any other enrollment of the same unit. The base module allows remotes to be enrolled over the top of other remotes, and also allows for the host to delete all enrolled remotes.

In addition to the three normal units, each base module allows for the enrollment of three emergency units. These units are enrolled via a special process of transferring the normal units from one base module into the emergency units of another base module over the RF link. The user interface on the receptor base is used to put the RF module in “emergency unit enroll mode”. The user interface on the transmitting base is used to instruct the RF module to transmit its units over the RF link.

The host may instruct the base radio module to exit enrollment mode unconditionally. There is also a command that allows the host to query the base radio during enrollment mode. If an enrollment has occurred, the base radio informs the host and exits enrollment mode. If an enrollment has not occurred, the base radio informs the host and stays in enrollment mode.

### RRF Module Electrical Specifications

General

| PARAMETER and CONDITIONS | UNITS | MIN | TYP | MAX |
|---|---|---|---|---|
| Supply Voltage | V | 3.1 | | 4.2 |
| Current Consumption (receive mode) | mA | — | 30 | |
| Current Consumption (transmit mode) | mA | — | 1000 | |
| Current Consumption (shutdown mode) | mA | — | .1 | |
| UART Data Rate | kBAUD | | 9.6 | |

RF Receiver

| PARAMETER and CONDITIONS | UNITS | MIN | TYP | MAX |
|---|---|---|---|---|
| RF Reception Frequency | MHz | — | 154.6 | — |
| IF Frequency | MHz | | 10.7 | |
| IF Bandwidth | kHz | | 30 | — |
| Sensitivity (direct injection | dBm | — | −114 | −107 |
| from a 50 Ohm source, antenna not | | | | |
| installed) | | | | |
| Dynamic Range (direct injection | dBm | 20 | 25 | |
| from a 50 Ohm source, antenna not | | | | |
| installed) | | | | |
| Open Air Range | Feet | 5,000 | 7,000 | — |

RF Transmitter

| PARAMETER and CONDITIONS | UNITS | MIN | TYP | MAX |
|---|---|---|---|---|
| Frequency Range | MHz | — | 154.6 | — |
| Frequency Deviation | kHz | 3 | 5 | — |
| Output power (into 50 Ohms, antenna | dBm | 27 | — | 33 |
| not installed) | | | | |
| Transmit duty cycle, Remote | % | | | 3.9 |
| Transmit duty cycle, Base | % | | .01 | 4.1 |

### Mechanical Specifications

Board

| CHARACTERISTIC | DESCRIPTION |
|---|---|
| Size | 1.775 in × 1.25 in |
| Material | .0625″ FR4 |

External Connections

| TER- | | |
|---|---|---|
| MINAL | DESCRIPTION | EXTERNAL CONNECTION |
| 1 | LED | Connection to anode of LED on external |
| | | board, through resistor on external board. |
| 2 | +3 V | Used for in-circuit programming, no |
| | | connection to external board |
| 3 | +Vbatt | Direct connection to battery |
| 4 | MCLR/ | Used for in-circuit programming, connection |
| | MOM_SW | to momentary switch to ground on external |
| | | board |
| 5 | UART_RX | Direct connection to UART_TX on external |
| | | board |
| 6 | UART_TX | Direct connection to UART_RX on external |
| | | board |
| 7 | GND | Direct connection to GND on external board |
| 8 | 1 pps | Direct connection to 1 pps signal on external |
| | | module |

### Production Configuration and Testing

Microcontroller Programming

The Microchip PIC18LF1220-I/SS Microcontroller is used on the RF module. This part may be programmed either before assembly or in circuit. There may be two different firmware versions, one for the base module and one for the remote module.

Functional Testing

The test fixture may communicate with the DUT by connecting to its UART lines. It may also have control of a test radio. The following procedure may be used to test the boards. The procedure is identical for base or remote radio boards.

Enter Test Mode

The DUT may enter test mode when reset with its momentary switch input held low. This is pin 4 of the connector, and TP6 of the board.

Dump Unique ID

EEPROM locations in the DUT microcontroller hold the unique 24-bit ID for the module. These locations must be programmed to random values by the test fixture. This occurs over the serial interface. The interface may use a standard UART communication format of 9600 baud, 8, N, 1. The command used to transfer the 24-bit ID to the DUT is a 4-byte command as follows, where ID1 is the most significant byte of the ID and ID3 is the least significant byte:
0x70
ID1
ID2
ID3

When the DUT receives this command, it may store the received ID in RAM. There may be no response back to the test fixture, and the ID may not be written to EEPROM at this time.

Send RF Packet to DUT

The test fixture may send an RF packet to the DUT. This packet is a special packet that may be recognized by the DUT when it is in test mode. Upon reception of this packet, the DUT may write the current ID residing in RAM to EEPROM.

Release Test Mode

The test fixture may release the test pin (TP6). The DUT may detect this release. If the DUT received the special RF packet from the test fixture while it was in test mode, it may read its ID from EEPROM and transmit a special packet of its own. This special packet will include its newly read ID. The test fixture will receive this packet and verify the ID against the one it sent to this unit over the serial interface.

### Software/Firmware

Described below is an example embodiment of a design and working of the firmware embedded into a base unit with the exception of the workings of the embOS Real Time Operating system. The internal workings of the embOS Real Time operating system is described in the embOS Ref and embOS ARM Ref specifications. The architecture and design of a base unit application (firmware) as discussed below is one example embodiment of the inventive subject matter. The architecture provides the overall breakdown of modules and their higher-level interdependence with one another. The design may provide specifications of the public interfaces and public data for the modules along with their responsibilities. A module, when used in this document, is a group of public interfaces that perform a logical service for the application. It may be coded into a single or multiple source files.

The following coding examples are for illustrative use only and should not be taken as a requirement of their use. The necessity is that the code efficiently fulfills the requirements of the public interfaces.

Acronyms and Abbreviations

The following acronyms and abbreviations are used within the text of this document.

| | |
|---|---|
| ADC | Analog to Digital Converter |
| API | Application Programming Interface |
| ECEF | Earth Centered, Earth Fixed. |
| Flash | A form of non-volatile memory |
| GPS | Global Positioning System |
| LCD | Liquid Crystal Display |
| LED | Light Emitting Diode |
| LLA | Latitude, Longitude, and Altitude |
| SRAM | Static Random Access Memory |

### DEFINITIONS

embOS—A real time operating system available from SEGGER Microcontroller Systeme GmbH. It is a multithreaded single application priority controlled operating system.
ECEF—Earth Centered, Earth Fixed uses three-dimensional xYZ coordinates (in meters) to describe the location of a GPS user or satellite. The origin is at the center of the earth, with the Z-axis piercing the North Pole, and the XY-axis defines the equatorial plane.
LAR Embedded Workbench—An integrated cross development environment for developing software for the ARM processor on Windows based hardware.
RF Module—Radio transceiver module. The base station and each of the collars may contain one of these. The Transceiver may be used to exchange GPS position and control information between the base station and the collars.
JTAG Port—A hardware debugging port supported by the IAR Embedded Workbench. It can also be used to burn the firmware into the flash memory before the debug cycle.
NavMan GPS Receiver—A hardware implementation of a GPS receiver with an onboard processor and software. Communicates through a serial port to the base unit hardware.

Notation and Conventions

Accuracy and tolerance for API parameters and firmware measurements may be within 10% unless otherwise specified.

### REFERENCES

| Reference | Title or Description |
|---|---|
| embOS Ref | embOS Real Time Operating System |
| | Software Version 3.28 CPU |
| | imdependent User's & Reference |
| | manual |
| embOS | embOS Real Time Operating System |
| ARM ref | CPU & Compiler specifics for ARM |
| | core using IAR Embedded Workshop |
| GPS Binary | SiRF Binary Protocol Reference Manual |
| Protocol | |
| NMEA | NMEA Reference Manual |
| Protocol | |
| 3D Compass | Applications of Magnetic Sensors for |
| Ref | Low Cost Compass Systems |
| Sharp CPU | LH75400/01/10/11 System-on-Chip |
| Ref | User's Guide |
| RF Module | RF Module Functional Specification |
| Functional | |
| Spec | |
| RF Module | RF Module Interface Specification |
| Interface | |
| Spec | |

### Application Module Descriptions

With reference to FIG. 7, each of the application modules 40-52 of the base unit 12, along with any algorithms used may be described in the sections below. Some modules are active objects that run in their own thread of execution. As active objects are running asynchronous with one another, collaboration and mailbox mechanisms are used to pass data between these modules.

Those modules that are not active objects, calls to the API are processed synchronously. Note that some of the modules that are active objects may present one or more API calls that are synchronous.

AD Converter

The AD Converter module 40 is an API used to access the Analog to Digital converter. All access to the ADC may be controlled through the AD Converter module 40. The AD Converter module 40 may be implemented using a singleton-coding pattern. The API may serialize the calls to the hardware so that calls from multiple threads of execution will work properly.

The API may implement an over sampling call. The over sampling call may up the ADC control bank to read the same analog line at all 16 of the samplings times. The raw ADC count values may be summed, 2 is added (as rounding), and the sum is then divided by 4. This increases the ADC precision from 10 bits to 12 bits (give or take some noise). While this API call is synchronous, the conversion is interrupt driven. This lessens the load on the CPU by causing the calling thread to be suspended while the conversion is taking place.

It is up to the consumer of this module to make sense of the return data. That is, the data being returned is raw. The caller of the AD Converter API must make the conversion from the raw data to a form more understandable to that module.

The following features may be available according to one or more embodiments of the inventive subject matter:
The AD Converter module 40 may be implemented using a singleton-coding pattern.
The AD Converter module 40 API may serialize access to the ADC hardware.
The AD Converter module 40 API may implement an over sampling call to increase the precision of the ADC from 10 bits to 12 bits. Equation to

$$use [ ( {\sum }_{i}^{16} samples [ i ] ) + 2 ] / 4$$

The over sampling call may suspend until the conversion is complete using an interrupt coding pattern.

Battery Module

The Battery Module 42 is an active object that monitors the voltage and the charging state of the LiIon battery in the base unit. It may also monitor the AC present state. It may periodically use the AD Converter module 40 to read the battery voltage and report the results to any registered collaborator. It may be coded using a singleton coding pattern.

The Battery Module 42 may contain and make available through API calls the state from the last sampling. Each sampling period is made up of 20 programmable interval times. At each of the 20 sampling periods, the state of the battery charge and AC present is checked against those of the saved state. If the state of either of these two have changed, a sampling sequence is started. Otherwise, if 20 sampling periods have expired, again, a sampling sequence is started.

The Battery Module 42 may make available through an API call, a method to synchronously cause a sampling sequence. The caller is blocked, a sampling sequence is performed, and the caller is resumed. The caller may then use the API to read the results of the sampling sequence.

The battery voltage is sampled across a resistor divider circuit. The AD Converter is set up to use Vcc as the upper reference voltage, and Gnd as the lower reference voltage. This produces 1024 counts across the 3.3V, or 4096 counts across the 3.3V when over sampled.

The following features may be available according to one or more embodiments of the inventive subject matter:
The Battery Module 42 may be coded using a singleton coding pattern.
Each Battery Module 42 sampling interval may be made up of 20 sampling periods. The default sampling period may be 1 second.
During each Battery Module 42 sampling period, the AC present status may be sampled. If the AC present status has changed, then a full sampling sequence may be performed.
During each Battery Module 42 sampling period, the Battery Charging status may be sampled. If the Battery Charging status has changed, then a full sampling sequence may be performed.
The Battery Module 42 API may provide a method to perform a full sampling sequence synchronously.
The Battery Module 42 API may provide API methods to retrieve the last sample battery voltage, the AC present status, and the Battery Charging status.
The conversion from the over sampled battery voltage ADC count to actual voltage may use the equation

double(ADCcount)×260≈100×3.3≈4096
The Battery Module 42 may provide an analyzer to convert the battery voltage into a number from 0 to 15 roughly indicating remaining battery life.

Compass Module

A base unit contains a 3-axis magnetic compass sensor with an accelerometer sensor used to determine the pitch and tilt of the platform. The Compass Module 44, an active object, may periodically, using the AD Converter Module 40, measure the raw X/Y/Z magnetic vectors magnitudes, along with the accelerometer pitch and roll magnitudes. The Compass Module 44 performs the necessary calculations to generate a magnetic vector. The Compass Module 44 also controls the degauss circuit; the set/reset straps of the magnetic compass sensors.

The Compass Module 44 is an active object coded using a singleton-coding pattern. It maintains the last sampled state of the magnetic compass and exposes it through its API calls. Also included in the API calls is a method to perform a synchronous compass measurement; methods to perform calibrations; and methods to persist and restore the calibration data.

When the accelerator sensor is in a plane tangential to the earth, the gravitational vector is perpendicular to the pitch and roll axis and should read “center scale”. This center scale reading needs to be calibrated to be zero. This is the only calibration that needs to be applied to the tilt/acceleration sensor.

The following features may be available according to one or more embodiments of the inventive subject matter:
The Compass Module 44 may provide a calibration method that determines the ADC count offsets of the accelerometer pitch and roll axis when the platform has no tilt or pitch.
The pitch may be calculated by the following equation

φ=a sin((countY−offsetX)/mCount) where countY is the value read
from the AD Converter, offsetX is the corresponding calibration offset and mCount represents the AD Converter count at 1 G which is calculated.
The roll may be calculated by the following equation

θ=a sin((countY−offsetY)/mCount) where countY is the value read from
the AD Converter, offsetY is the corresponding calibration offset and mCount represents the AD Converter count at 1 G which is calculated.

The magnetic sensor can measure the magnitude of the magnetic vector in all 3 axis. To properly convert the AD Converter counts, both the Op Amp reference voltage (Vref) must be measured as must the bridge offset. The bridge offset is measured during the degauss cycle, in between the set and reset pulses. To compensate for soft and hard iron influences, a further offset and scaling of the value measured along each axis is necessary.

The following features may be available according to one or more embodiments of the inventive subject matter:
The Compass Module 44 may perform a degauss of the magnetic compass bridges once every 10 minutes.
During the degauss cycle, the Compass Module 44 may read and determine the bridge offsets.
The Compass Module 44 may provide calibration routines to determine the offsets due to soft and hard iron influence.
During the X/Y/Z calibration, Compass Module 44 may keep track of the minimum and maximum values of Xcompass−Vref−XbridgeOffset, Ycompass−Vref−YbridgeOffset, and Zcompass−Vref−ZbridgeOffset.

The Compass Module 44 may calculate the magnetic compass offsets with the equations (Xmax−Xmin)/2−Xmax, (Ymax−Ymin)/2−Ymax, and (Zmax−Zmin)/2−Zmax

Given the pitch, roll and the magnitude of the magnetic vector in all three axes it is possible to determine the magnetic heading. Due to the inverted placement of the components (placed on the bottom side of the board), the equation differs slightly from the classic form.

The following features may be available according to one or more embodiments of the inventive subject matter:

The Compass Module 44 may correct the magnetic vector magnitude values, read with the AD Converter, using the following equations,

xRaw=(Xvalue−Vref−XbridgeOffset+Xoffset)*Xscale,

yRaw=(Yvalue−Vref−YbridgeOffset+Yoffset)*Yscale, and

zRaw=(Zvalue−Vref−ZbridgeOffset+Zoffset)*Zscale.

The Compass Module 44 may use the following equations to determine the magnetic heading of the unit.

x=xRaw*cos(φ)+yRaw*sin(θ)*sin(θ)+zRaw*cos(θ)*sin(φ),

y=yRaw*cos(θ)−zRaw*sin(θ), and heading=a tan 2(y,x)*180/π
The Compass Module 44 may perform sampling of the magnetic and accelerometer sensors at a rate of 1 complete sample each 1 second and convert those reading to a magnetic heading.

The Compass Module 44 API may make available the last measured magnetic heading.

GPS Module

The purpose of the GPS Module 46 code is to initialize the NavMan GPS receiver, receive and process sentences from it. The NavMan GPS receiver can send sentences in either a binary protocol or the more standard. NMEA ASCII protocol. The GPS Module 46 may setup the NavMan GPS Receiver to use the NMEA ASCII protocol.

The GPS Module 46 may provide methods for the decoding of the NMEA sentences for GPS position ($GPGGA) and GPS velocity ($GPVTG). Additionally, the GPS Module 46 may keep the last received and last valid decoded GPS position and the last received and last valid decoded GPS velocity data.

The GPS Module 46 may provide API methods to work with distance and headings; and with easting/northing conversions. The equations used to convert the latitude and longitude to a given easting/northing starting at an arbitrary longitude are given in the figures below.

The following features may be available according to one or more embodiments of the inventive subject matter:
The GPS Module 46 may be coded as a singleton active object with a collaborative mechanism.
The GPS Module 46 may initialize the NavMan GPS module to return NMEA $GPGGA and $GPVTG sentences at a desired rate.
The GPS Module 46 API may provide methods to decode the NMEA $GPGGA and $GPVTG sentences.
The GPS Module 46 may contain API methods to convert latitude and longitude into easting/northing values using the equations in Equations Sets 1, 2, 3.
The GPS Module 46 API may provide the last measured GPS position and the last measured valid GPS position.
The GPS Module 46 API may provide the last measured velocity and heading reading in addition to the last measured valid velocity and heading reading.

$$\begin{matrix}Equations for Easting \text{/} Northing Part 1 & \\ a = 6378137 \\ b = 6356752.3142 \\ f = \frac{a - b}{b} \\ {k}_{0} = 0.9996 \\ e = \sqrt{1 - \frac{{b}^{2}}{{a}^{2}}} \\ {e}^{′ 2} = {( \frac{ea}{b} )}^{2} = \frac{{e}^{2}}{1 - {e}^{2}} \\ n = \frac{a - b}{a + b} \\ φ = \frac{a ( 1 - {e}^{2} )}{{( 1 - {e}^{2} {sin}^{2} ( lat ) )}^{\frac{3}{2}}} \\ v = \frac{a}{{( 1 - {e}^{2} {sin}^{2} ( lat ) )}^{\frac{1}{2}}} \\ p = ( long - {long}_{0} ) \\ sin {1}^{″} ≅ \frac{π}{180 ⋆ 60 ⋆ 60} & Equation Set 1\end{matrix}$$

$$\begin{matrix} Equations for Easting \text{/} Northing Part 2 & \\ {A}^{′} ≅ a [ 1 - n + \frac{5}{4} ( {n}^{2} - {n}^{3} ) = \frac{81}{64} ( {n}^{4} - {n}^{5} ) ] \\ {B}^{′} ≅ \frac{3 an}{2} [ 1 - n + \frac{7}{8} ( {n}^{2} - {n}^{3} ) + \frac{55}{64} ( {n}^{4} - {n}^{5} ) ] \\ {C}^{′} ≅ \frac{15 {an}^{2}}{16} [ 1 - n + \frac{3}{4} ( {n}^{2} - {n}^{3} ) ] \\ {D}^{′} ≅ \frac{35 {an}^{3}}{48} [ 1 - n + \frac{11}{16} ( {n}^{2} - {n}^{3} ) ] \\ {E}^{′} ≅ \frac{315 {an}^{4}}{51} [ 1 - n ] \\ S = {A}^{′} lat - {B}^{′} sin ( 2 lat ) + {C}^{′} sin ( 4 lat ) - {D}^{′} sin ( 6 lat ) + {E}^{′} sin ( 8 lat ) & Equation Set 2\end{matrix}$$

$$\begin{matrix} Equations for Easting \text{/} Northing Part 3 & \\ {K}^{′} = {Sk}_{0} \\ {K}^{″} = \frac{{{k}_{0} ( sin {1}^{″} )}^{2} v sin ( lat ) cos ( lat )}{2} \\ {{{K}^{′}}^{′}}^{′} = [ \frac{{{k}_{0} ( sin {1}^{″} )}^{4} v sin ( lat ) {cos}^{3} ( lat )}{24} ] [ \begin{matrix}\begin{matrix}5 - {tan}^{2} ( lat ) + \\ 9 {e}^{′ 2} {cos}^{2} ( lat ) +\end{matrix} \\ 4 {e}^{′4} {cos}^{4} ( lat )\end{matrix} ] \\ {{{{K}^{′}}^{′}}^{′}}^{′} = {k}_{0} sin {1}^{″} v cos ( lat ) \\ {{{{{K}^{′}}^{′}}^{′}}^{′}}^{′} = ( \frac{{{k}_{0} ( sin {{{1}^{′}}^{′}}^{′} )}^{3} v {cos}^{3} ( lat )}{6} ) [ \begin{matrix}1 - {tan}^{2} ( lat ) + \\ {{e}^{′}}^{2} {cos}^{2} ( lat )\end{matrix} ] \\ y = northing = {K}^{′} + {K}^{″} {p}^{2} + {{{K}^{′}}^{′}}^{′} + {p}^{4} \\ x = easting = {{{{K}^{′}}^{′}}^{′}}^{′} 4 p + {{{{{K}^{′}}^{′}}^{′}}^{′}}^{′} {p}^{3} & Equation Set 3\end{matrix}$$

The GPS Module 46 API may provide methods of converting ECEF coordinates into longitude and latitude coordinates

LCD Module

The LCD module 48 is responsible for the placement of data onto the LCD screen hardware. It is also used to drive the backlighting of the LCD hardware. The hardware implements the LCD hardware as a simple frame buffer device. The hardware supports either a 12 bit direct color, or an 8 bit pallefized color model.

The following features may be available according to one or more embodiments of the inventive subject matter:
The LCD Module 48 may be coding using a singleton pattern.
The LCD Module 48 may provide API methods to control the LCD backlighting hardware.

The Base Unit may use the 8 bit palletized color model with a single fixed pallet loaded into the CPU onboard pallet RAM. The CPU also has a single DMA channel that can handle memory-to-memory data transfer. This makes it possible to use a off screen frame buffer to draw on, then use the DMA to transfer the contents into the LCD frame buffer. This may make the drawing look smoother. Additionally, the DMA channel can be used to quickly clear the frame buffer to a single pallet value.

The following features may be available according to one or more embodiments of the inventive subject matter:
The LCD Module 48 may run the LCD hardware in 8 bit palletized color mode.
The LCD Module 48 may provide a single global color pallet.
The LCD Module 48 API may provide methods to move data from an off screen frame buffer to the on screen frame buffer using hardware DMA.
The LCD Module 48 API may provide methods to fill a frame buffer with a single pallet color using hardware DMA.

All drawing, whether it is graphics or text, requires a graphics context. This graphics context contains information about background colors, foreground colors, currently selected font, clipping region, raster operation, etc

The graphics operations may include the ability to draw lines, rectangles, ellipses, and bitmaps. The text operations allow the drawing of a single character or a string of characters.

The following features may be available according to one or more embodiments of the inventive subject matter:
The LCD Module 48 API may provide methods that perform drawing of lines, rectangles, ellipses, and bitmaps.
The LCD Module 48 API may provide methods that perform drawing of single characters along with strings of characters.
The LCD Module 48 API may provide multiple font sizes.

RF Module

The RF Module 50 is used to communicate with the RF Radio hardware. All communications from the Base Unit to the RF Radio is through a serial UART port. Communications with the RF Radio hardware is with any desired protocol.

The RF Radio keeps in contact with a number of remote (collar) units that have been enrolled. The enrolling process is used to pair a remote collar unit with a single Base Unit. Once enrolled, the remote collar unit may communicate its GPS position to the Base Unit.

The RF Module 50 API may provide methods of converting the ECEF coordinates returned by the remote collar unit into easting and nothing numbers.

### Sound Module

The Sound Module 52 is used to drive the speaker in the base unit. The speaker is hooked up to one of the counter outputs through an amplifier circuit. The amount of amplification is controlled through a digital potentiometer. The Sound Module 52 provides API methods to set the volume, play a single tone, or play multiple tones.

The following features may be available according to one or more embodiments of the inventive subject matter:
The Sound Module 52 may be coded using an active object and singleton coding patterns.
The Sound Module 52 may provide API methods to asynchronously play a single or multiple tones.
The Sound Module 52 may provide an API method to control the volume of the sound.

Embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, may be apparent to those of skill in the art upon reviewing the above description.

The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

1. An apparatus comprising:
an input to obtain location data; and
a processor to determine if the location data represents a location within a boundary.

2. The apparatus of claim 1, wherein the location data is received from a portable remote device.

3. The apparatus of claim 1, wherein the boundary is defined by an area with a plurality of linear sides.

4. The apparatus of claim 1, wherein the boundary area is defined by a series of coordinates.

5. The apparatus of claim 1, wherein the boundary is defined by a combination of points and vectors.

6. The apparatus of claim 1, further comprising a boundary creation module to define the boundary.

7. The apparatus of claim 6, further comprising a memory to store the defined boundary.

8. The apparatus of claim 1, further comprising a GPS module to obtain position information for the apparatus.

9. The apparatus of claim 1, wherein the boundary is defined by GPS based data.

10. The apparatus of claim 1, further comprising an alert module to notify a user that the location data represents a location outside of the boundary.

11. A locating system comprising:
a first portable device including a GPS unit and a transmitter device to transmit location data;
a second device including one or more data storage components storing perimeter information defining a physical perimeter; and
the second device including a data input port, the data input port to receive the location data from the first portable device.

12. The locating system of claim 11, further comprising a tracking system to monitor the location data and determine if the first portable device is within the perimeter.

13. The locating system of claim 12, wherein the tracking system is disposed within the base device.

14. The locating system of claim 11, further comprising a perimeter creation tool to gather GPS data defining a perimeter.

15. The locating system of claim 11, wherein the perimeter creation tool is disposed in the base device.

16. The locating system of claim 11, wherein the radio transmitter transmits at a power above about 2 watts.

17. The locating system of claim 11, wherein the radio transmitter communicates the GPS location data substantially continuously to the radio receiver.

18. The locating system of claim 11, further comprising an alerting system in communication with the remote device.

19. The locating system of claim 18, further comprising an electric shock device triggered by the alerting system.

20. The locating system of claim 11, further comprising a third device, the location of the third device and the location of the second device defining perimeter information.

21. A method comprising:
defining a perimeter using GPS based coordinates;
receiving GPS location data through communication with a GPS enabled remote device;
tracking the remote device based on the GPS location data; and
alerting a base device when the remote device is outside of the perimeter.

22. The method of claim 21, wherein the defining a perimeter is done by the base device.

23. The method of claim 21, wherein the perimeter has a plurality of linear sides.

24. The method of claim 21, further comprising receiving GPS location data through communication with a second GPS enabled remote device;

25. The method of claim 21, further comprising enrolling the remote device with the base device

26. The method of claim 21, further comprising transmitting a command from the base device to the remote device.

27. A locating device comprising:
a GPS module;
a storage module to store a perimeter of GPS based coordinates; and
an input port to receive location information from a remote unit.

28. The locating device of claim 27, further comprising a tracking module to determine the location of the remote unit with respect to the perimeter.

29. The locating device of claim 27, further comprising a display to show the location of the remote unit with respect to the perimeter.

30. The locating device of claim 29, wherein the display shows the position of the remote unit when it is outside of the perimeter.

31. The locating device of claim 30, wherein the position of the remote device is shown with respect to the location of the locating device.

32. The locating device of claim 27, further comprising a display to show the location of the remote unit with respect to the base unit.

33. The locating device of claim 27, further comprising a perimeter creation tool.

34. The locating device of claim 33, wherein the radio transmitter sends a command to the remote unit based on a information from the tracking module.

35. The locating device of claim 33, wherein the radio transmitter sends a command to the remote unit based on a user input.

36. The locating device of claim 27, wherein the input port receives location information from a plurality of remote units.

37. The locating device of claim 36, further comprising a first display mode to display the remote units located within the perimeter, and a second display mode to display the remote units located outside of the perimeter.
